(19) United States
(12) Patent Application Publication
(10) Pub. No.: US 2026/0316095 A1
(43) Pub. Date: Oct. 15, 2026

(54) WET WIPE LIQUID SPRAYING STRUCTURE FOR WET WIPE PRODUCTION

(71) Applicant: Taizhou Yasuda Biotechnology Co., Ltd., Taizhou City (CN)

(72) Inventor: Haiyu Mao, Taizhou Development Zone (CN)

(21) Appl. No.: 19/464,806

(22) Filed: Jan. 30, 2026

(30) Foreign Application Priority Data
Apr. 10, 2025 (CN) 202510444128.5

(51) Int. Cl. B05B 1/14; B05B 12/00; B05B 13/02; B05B 13/04

(52) U.S. Cl. CPC B05B 1/1422; B05B 12/004; B05B 13/0221; B05B 13/041; B05B 13/0447

(57) ABSTRACT

A wet wipe liquid spraying structure for wet wipe production is provided. The wet wipe liquid spraying structure for wet wipe production includes a transmission system arranged on an inner side of a spraying base external thread tube; two parallel inner walls of the spraying base external thread tube are fixedly connected to two symmetrically arranged linear guide rail external thread tubes; a uniform liquid supplier external thread tube is arranged between the two linear guide rail external thread tubes; the uniform liquid supplier includes a power trolley and a liquid supply tank arranged below the power trolley; one side of the liquid supply tank is fixedly connected to an internal hose in a penetrating manner; and one end, away from an inner wall of the liquid supply tank, of the internal hose is connected to a liquid supply transfer tube through a pipeline.

### CROSS REFERENCE TO RELATED APPLICATION

This application claims priority to Chinese Patent Application No. 202510444128.5 filed on Apr. 10, 2025, which is hereby incorporated by reference in its entirety.

### TECHNICAL FIELD

The present disclosure belongs to the technical field of wet wipe liquid spraying for wet wipe production, and specifically to, a wet wipe liquid spraying structure for wet wipe production.

### BACKGROUND

Wet wipes are made by adding a proper amount of wet wipe liquid into non-woven fabrics, woven fabrics, or lint-free paper serving as a carrier. The wet wipes are divided into ordinary wet wipes, sanitary wet wipes, and disinfecting wet wipes. The wet wipes are widely used for cleaning purposes, and can quickly clear dust, oil, and other dirt from hands and faces. The wet wipes can also clean stains from surfaces of furniture, office supplies, children's toys, and other objects while providing antibacterial and disinfecting functions. Antibacterial ingredients in the sanitary and disinfecting wet wipes can effectively kill common bacteria such as escherichia coli, staphylococcus aureus, and candida albicans, to lower a risk of bacterial infections. Additionally, some wet wipes can also provide moisturizing and skincare functions because of their skincare ingredients such as aloe vera, glycerin, and vitamin E, so that the wet wipes can hydrate and nourish the skin during cleaning, and alleviate dryness and discomfort. Moreover, there are also makeup remover wet wipes which contain makeup remover ingredients that can effectively remove facial makeups, dirt, and oil. It offers a convenient and efficient solution for situations such as travel or when thorough makeup removal is not feasible.

During processing of wet wipes, cut and folded carriers need to be sprayed. In the existing art, atomizing nozzles are commonly used for spraying of the wet wipes. However, the atomizing nozzles have a wide spraying range during spraying and provide uniform spraying, but the spraying range is often larger than surface areas of the wet wipes. As a result, the wet wipe liquid is not fully absorbed by the carriers and the wet wipe liquid is wasted.

### SUMMARY

A technical problem to be solved in the present disclosure is to overcome the shortcomings in the existing art, and a wet wipe liquid spraying structure for wet wipe production is provided.

A technical solution used to solve the above technical problem is as follows: A wet wipe liquid spraying structure for wet wipe production includes a transmission system arranged on an inner side of a spraying base. Two parallel inner walls of the spraying base are fixedly connected to two symmetrically arranged linear guide rails. A uniform liquid supplier is arranged between the two linear guide rails.

Through the above technical solution, the transmission system can convey a folded wet wipe carrier and spray a wet wipe carrier at a transmission system position. The linear guide rails support a power trolley, so that the power trolley horizontally moves on the linear guide rails. The uniform liquid supplier can quantitatively inject wet wipe liquid into a liquid supply tank, to spray proper wet wipe liquid to wet wipes of different size standards.

The uniform liquid supplier includes a power trolley and a liquid supply tank arranged below the power trolley. One side of the liquid supply tank is fixedly connected to an internal hose in a penetrating manner; one end, away from an inner wall of the liquid supply tank, of the internal hose is connected to a liquid supply transfer tube through a pipeline; and a plurality of uniformly distributed contact spraying heads are arranged on a lower surface of the liquid supply tank in a penetrating manner.

Through the above technical solution, the liquid supply tank can quantitatively store wet wipe liquid and spray a fixed amount of wet wipe liquid onto a wet wipe carrier. The wet wipe liquid is injected into the liquid supply tank through the internal hose and the liquid supply transfer tube, and the contact spraying heads can release the wet wipe liquid when in contact with the wet wipe carrier.

Further, the upper surface of the liquid supply tank is fixedly connected to a plurality of uniformly distributed limiting columns. An upper surface of the power trolley is fixedly connected to a limiter in a penetrating manner. The plurality of limiting columns are slidably connected to the limiter at a corresponding position in a penetrating manner. A plurality of uniformly distributed buffer springs are fixedly connected between the upper surface of the liquid supply tank and a lower surface of the power trolley.

Through the above technical solution, the limiting columns cooperate with the limier to cause the liquid supply tank to move in a vertical direction under the action of Z-shaped rails. The power trolley provides power for movement of the liquid supply tank, and the buffer springs cause the liquid supply tank to move more stably and gently in the vertical direction.

Further, positions, which are located below the linear guide rails, on the two parallel inner walls of the spraying base are fixedly connected to Z-shaped rails; starting positions of the Z-shaped rails are fixedly connected to photoelectric sensors; two sides of the liquid supply tank are rotatably connected to limiting wheels; the limiting wheels are in rolling connection with the Z-shaped rails at corresponding positions; and a power wheel of the power trolley is in rolling connection with the linear guide rails at corresponding positions.

Through the above technical solution, the Z-shaped rails can implement up-down movement of the liquid supply tank. When the liquid supply tank moves downwards, a control piston can be used for blocking to stop supplying liquid to the liquid supply tank, so that the capacity of the wet wipe liquid in the liquid supply tank is fixed. Furthermore, when the Z-shaped rails drive the liquid supply tank to move downwards, a plug moves upwards, so that the wet wipe liquid is sprayed from an outer spraying tube. The photoelectric sensors can be sensed when the wet wipe carrier is conveyed, thereby controlling the power trolley to move synchronously, and the limiting wheels make the liquid supply tank move on the Z-shaped rails.

Further, the bottom of the liquid supply transfer tube is opened; a surface of the liquid supply transfer tube is slidably connected to a control piston in a penetrating manner; one side of a surface of the control piston is slidably connected to a lifting column in a penetrating manner; a bottom of the lifting column is fixedly connected to a floating piston; an upper surface of the liquid supply tank is in threaded connection with an external thread tube in a penetrating manner; and a bottom of the external thread tube is rotatably connected to a control guide column, and the control guide column is fixed to a top of the liquid supply transfer tube.

Through the above technical solution, the control piston is controlled by an adjustment plate and the floating piston to add or stop adding the wet wipe liquid into the liquid supply tank, thus quantitatively adding the wet wipe liquid into the wet wipe carrier. The up-down movement of the external thread tube can control the liquid supply transfer tube to move up and down, thereby controlling the adding amount of the wet wipe liquid. Furthermore, a portion of the control piston that is located below the liquid supply transfer tube is made of a rubber material. When the liquid supply transfer tube moves up and down, the control piston can be controlled normally by the adjustment plate.

Further, a limiting slot is formed in an inner wall of the external thread tube. An outer wall of the lifting column is fixedly connected to two symmetrically arranged limiting blocks. The limiting blocks are slidably connected to the limiting slot at a corresponding position.

Through the above technical solution, the mutual cooperation between the limiting slot and the limiting blocks can achieve vertical lifting of the lifting column, and the lifting column cannot fall off from the external thread tube.

Further, each of the plurality of contact spraying heads includes an outer spraying tube fixedly connected to a bottom of the liquid supply tank in a penetrating manner; an inner wall of the outer spraying tube is fixedly connected to an annular supporting ring; a plug is arranged above the outer spraying tube; and a reset spring is fixedly connected between a lower surface of the plug and an upper surface of the supporting ring.

Through the above technical solution, the supporting ring can implement fixed mounting of the reset spring, and the reset spring can pull the plug downwards to attach the plug to the inner bottom wall of the liquid supply tank, thus avoiding leakage of the wet wipe liquid.

Further, a center of the lower surface of the plug is fixedly connected to a sliding rod. A bottom of the sliding rod is fixedly connected to a trigger head. The plug is located above an inner bottom wall of the liquid supply tank, and the trigger head is located below the liquid supply tank.

Through the above technical solution, the sliding rod can implement linkage between the trigger head and the plug. When the trigger head is pressed to touch the wet wipe carrier, the trigger head and the plug move upwards under the action of the pressure, and the wet wipe liquid flows out of the plug. The wet wipe liquid is absorbed by the wet wipe carrier to implement spraying of the wet wipe liquid.

Further, an upper surface of the spraying base is fixedly connected to a fixed mounting platform; a surface of the fixed mounting platform is fixedly connected to a liquid storage tank body; the liquid storage tank body is connected to the internal hose of the liquid supply tank through a conveying hose; the transmission system includes two symmetrically arranged synchronous belt wheels that are rotatably connected to the spraying base; a synchronous conveyor belt is arranged between the two synchronous belt wheels; a side wall of the spraying base is fixedly connected to a driving motor; and a driving end of the driving motor is connected to rotating shafts of the synchronous belt wheels at corresponding positions.

Through the above technical solution, the fixed mounting platform can stably and fixedly mount the liquid storage tank. The liquid storage tank provides wet wipe liquid to the liquid supply tank through the internal hose and the conveying hose. The synchronous conveyor belt and the synchronous belt wheels cooperate with each other to convey the wet wipe carrier and spray the wet wipe carrier. The driving motor provides power to the synchronous belt wheels.

Further, the positions, which are located below the linear guide rails, on the two parallel inner walls of the spraying base are fixedly connected to jacking plates; two symmetrically arranged through slots are formed in sides, which are close to the liquid supply transfer tube, of two parallel inner walls of the liquid supply tank; an adjustment plate is arranged below the control piston; the adjustment plate is slidably connected to the through slots in a penetrating manner; and inner walls of the through slots and the adjustment plate are blocked by rubber soft films.

Through the above technical solution, when the liquid supply tank drops, the jacking plates can jack the adjustment plate, which can make the control piston float to block the liquid supply transfer tube. That is, when the liquid supply tank drops for spraying, new wet wipe liquid will not be added into the liquid supply tank, thus achieving quantitative spraying. The blocking performed by the rubber soft films can avoid leakage of the wet wipe liquid from the through slots.

The beneficial effects of the present disclosure are as follows: (1) By the arrangement of the contact spraying heads, when the wet wipe carrier moves to a position directly below the plurality of contact spraying heads, the power trolley can move together with the wet wipe carrier, and a contact spraying head moves downwards and is in contact with the wet wipe carrier. Under the pressure of the contact spraying head, the plug moves upwards, and the wet wipe liquid flows out of the outer spraying tube. The wet wipe liquid that flows out is fully absorbed by the wet wipe carrier, and no liquid flows out of contact spraying heads that are in no contact with the wet wipe carrier, so that the sprayed wet wipe liquid is fully absorbed by the wet wipe carrier, and the spraying is also uniform, which effectively saves the wet wipe liquid and reduces production costs. (2) By the arrangement of the uniform liquid supplier, when the uniform liquid supplier is located above the Z-shaped rails, the liquid supply transfer tube adds the wet wipe liquid into the liquid supply tank. When the liquid reaches a predetermined amount, the liquid supply transfer tube is blocked. When the uniform liquid supplier moves to the position below the Z-shaped rails, the adjustment plate moves upwards, thus compressing the control piston, so that a fixed amount of wet wipe liquid in the liquid supply tank is added into the wet wipe carrier, and there will be no excessive spraying on the wet wipe carrier caused by repeated adding of the wet wipe liquid due to a decrease in a liquid level of the wet wipe liquid, which makes the adding amount of the wet wipe liquid more accurate.

### BRIEF DESCRIPTION OF THE DRAWINGS

FIG. 1 is a structural diagram of a first view of a wet wipe liquid spraying structure for wet wipe production according to the present disclosure;

FIG. 2 is a structural diagram of a second view of a wet wipe liquid spraying structure for wet wipe production according to the present disclosure;

FIG. 3 is a structural diagram of a Z-shaped rail of a wet wipe liquid spraying structure for wet wipe production according to the present disclosure;

FIG. 4 is a three-dimensional diagram of a uniform liquid supplier of a wet wipe liquid spraying structure for wet wipe production according to the present disclosure;

FIG. 5 is a partially structural diagram of a uniform liquid supplier of a wet wipe liquid spraying structure for wet wipe production according to the present disclosure;

FIG. 6 is a cross-sectional diagram of a liquid supply tank of a wet wipe liquid spraying structure for wet wipe production according to the present disclosure;

FIG. 7 is a cross-sectional diagram of assembling of a liquid supply transfer tube of a wet wipe liquid spraying structure for wet wipe production according to the present disclosure;

FIG. 8 is a cross-sectional diagram of a contact spraying head of a wet wipe liquid spraying structure for wet wipe production according to the present disclosure; and

FIG. 9 is a cross-sectional diagram of a fixed supporting seat of a wet wipe liquid spraying structure for wet wipe production according to the present disclosure.

Reference numerals in the accompanying drawings: 1: spraying base; 2: linear guide rail; 3: fixed mounting platform; 4: liquid storage tank body; 5: driving motor; 6: synchronous belt wheel; 7: synchronous conveyor belt; 8: uniform liquid supplier; 80: power trolley; 81: limiter; 82: limiting column; 83: conveying hose; 84: liquid supply tank; 85: limiting wheel; 86: buffer spring; 87: liquid supply transfer tube; 88: control piston; 89: floating piston; 800: adjustment plate; 801: through slot; 802: lifting column; 803: external thread tube; 804: outer spraying tube; 805: limiting slot; 806: limiting block; 807: reset spring; 808: plug; 809: supporting ring; 810: sliding rod; 811: trigger head; 812: internal hose; 813: control guide column; 9: Z-shaped rail; 10: photoelectric sensor; and 11: jacking plate.

### DETAILED DESCRIPTION OF THE EMBODIMENTS

In order to make the objectives, technical solutions, and advantages of the present disclosure clearer, the following is a further detailed explanation of the present disclosure in conjunction with the accompanying drawings and embodiments. It should be understood that the specific embodiments described here are only intended to explain the present disclosure and are not intended to limit the present disclosure.

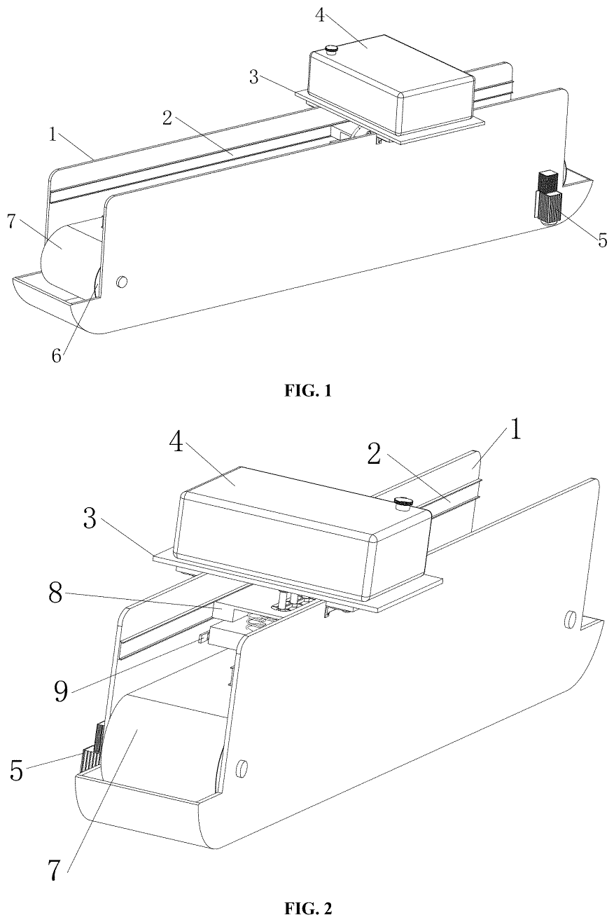

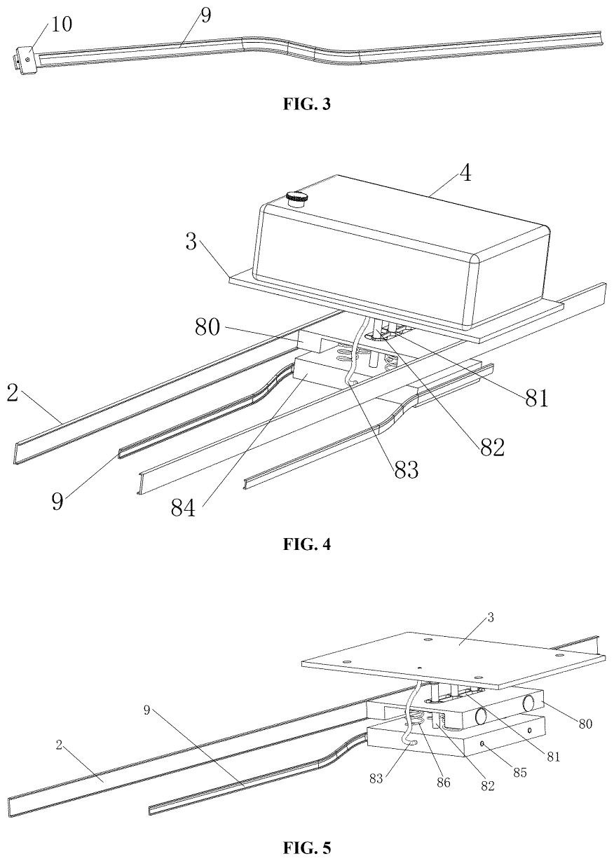

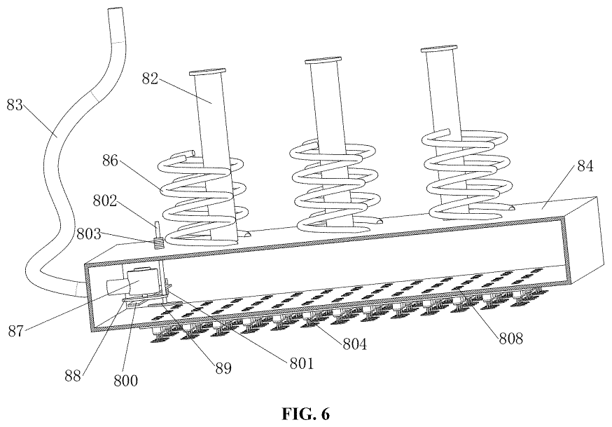

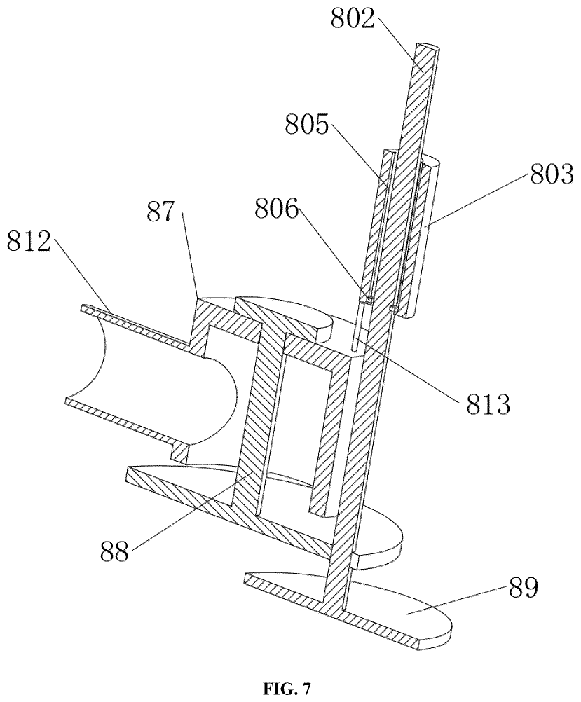

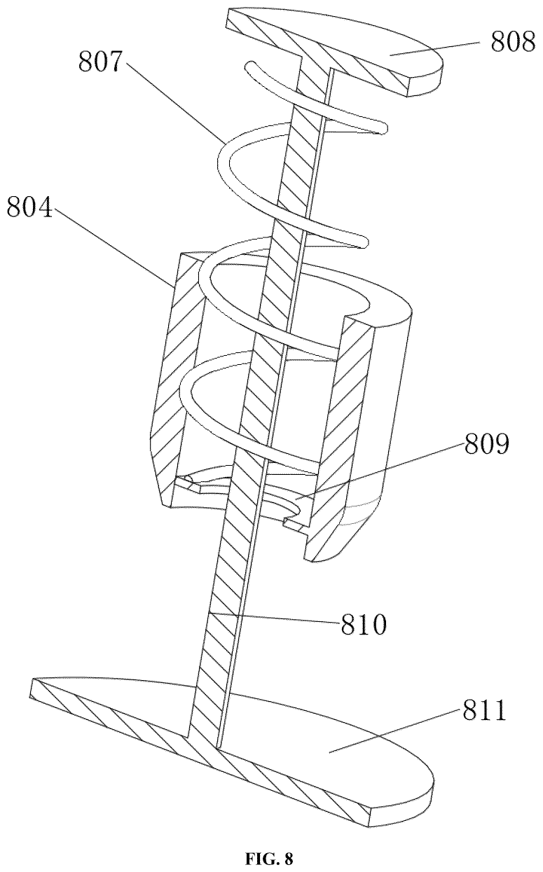

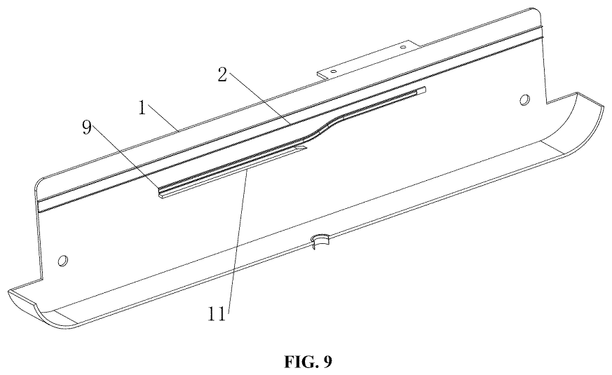

As shown in FIG. 1 to FIG. 9, a wet wipe liquid spraying structure for wet wipe production includes a transmission system arranged on an inner side of a spraying base 1. Two parallel inner walls of the spraying base 1 are fixedly connected to two symmetrically arranged linear guide rails 2. A uniform liquid supplier 8 is arranged between the two linear guide rails 2. The transmission system can convey a folded wet wipe carrier and spray a wet wipe carrier at a transmission system position. The linear guide rails 2 support a power trolley 80, so that the power trolley 80 horizontally moves on the linear guide rails 2. The uniform liquid supplier 8 can quantitatively inject wet wipe liquid into a liquid supply tank 84, to spray proper wet wipe liquid to wet wipes of different size standards.

An upper surface of the spraying base 1 is fixedly connected to a fixed mounting platform 3. A surface of the fixed mounting platform 3 is fixedly connected to a liquid storage tank body 4. The liquid storage tank body 4 is connected to an internal hose 812 of the liquid supply tank 84 through a conveying hose 83. The transmission system includes two symmetrically arranged synchronous belt wheels 6 that are rotatably connected to the spraying base 1. A synchronous conveyor belt 7 is arranged between the two synchronous belt wheels 6. A side wall of the spraying base 1 is fixedly connected to a driving motor 5. A driving end of the driving motor 5 is connected to rotating shafts of the synchronous belt wheels 6 at corresponding positions. The fixed mounting platform 3 can stably and fixedly mount the liquid storage tank 4. The liquid storage tank 4 provides wet wipe liquid to the liquid supply tank 84 through the internal hose 812 and the conveying hose 83. The synchronous conveyor belt 7 and the synchronous belt wheels 6 cooperate with each other to convey the wet wipe carrier and spray the wet wipe carrier. The driving motor 5 provides power to the synchronous belt wheels 6.

Further, positions, which are located below the linear guide rails 2, on the two parallel inner walls of the spraying base 1 are fixedly connected to Z-shaped rails 9. Starting positions of the Z-shaped rails 9 are fixedly connected to photoelectric sensors 10. Two sides of the liquid supply tank 84 are rotatably connected to limiting wheels 85. The limiting wheels 85 are in rolling connection with the Z-shaped rails 9 at corresponding positions. A power wheel of the power trolley 80 is in rolling connection with the linear guide rails 2 at corresponding positions. The Z-shaped rails 9 can implement up-down movement of the liquid supply tank 84. When the liquid supply tank 84 moves downwards, a control piston 88 can be used for blocking to stop supplying liquid to the liquid supply tank 84, so that the capacity of the wet wipe liquid in the liquid supply tank 84 is fixed. Furthermore, when the Z-shaped rails 9 drive the liquid supply tank 84 to move upwards, a plug 808 moves upwards, so that the wet wipe liquid is sprayed from an outer spraying tube 804. The photoelectric sensors 10 can be sensed when the wet wipe carrier is conveyed, thereby controlling the power trolley 80 to move synchronously, and the limiting wheels 85 make the liquid supply tank 84 move on the Z-shaped rails.

The uniform liquid supplier 8 includes a power trolley 80 and a liquid supply tank 84 arranged below the power trolley 80. One side of the liquid supply tank 84 is fixedly connected to an internal hose 812 in a penetrating manner. One end, away from an inner wall of the liquid supply tank 84, of the internal hose 812 is connected to a liquid supply transfer tube 87 through a pipeline. A plurality of uniformly distributed contact spraying heads are arranged on a lower surface of the liquid supply tank 84 in a penetrating manner. The liquid supply tank 84 can quantitatively store wet wipe liquid and spray a fixed amount of wet wipe liquid onto a wet wipe carrier. The wet wipe liquid is injected into the liquid supply tank 84 through the internal hose 812 and the liquid supply transfer tube 87, and the contact spraying heads can release the wet wipe liquid when in contact with the wet wipe carrier.

Each of the plurality of contact spraying heads includes an outer spraying tube 804 fixedly connected to a bottom of the liquid supply tank 84 in a penetrating manner. An inner wall of the outer spraying tube 804 is fixedly connected to an annular supporting ring 809. A plug 808 is arranged above the outer spraying tube 804. A reset spring 807 is fixedly connected between a lower surface of the plug 808 and an upper surface of the supporting ring 809. The supporting ring 809 can implement fixed mounting of the reset spring 807, and the reset spring 807 can pull the plug 808 downwards to attach the plug 808 to the inner bottom wall of the liquid supply tank 84, thus avoiding leakage of the wet wipe liquid.

A center of the lower surface of the plug 808 is fixedly connected to a sliding rod 810. A bottom of the sliding rod 810 is fixedly connected to a trigger head 811. The plug 808 is located above an inner bottom wall of the liquid supply tank 84, and the trigger head 811 is located below the liquid supply tank 84. The sliding rod 810 can implement linkage between the trigger head 811 and the plug 808. When the trigger head 811 is pressed to touch the wet wipe carrier, the trigger head 811 and the plug 808 move upwards under the action of the pressure, and the wet wipe liquid flows out of the plug 808. The wet wipe liquid is absorbed by the wet wipe carrier to implement spraying of the wet wipe liquid.

A bottom of the liquid supply transfer tube 87 is opened. A surface of the liquid supply transfer tube 87 is slidably connected to a control piston 88 in a penetrating manner. One side of a surface of the control piston 88 is slidably connected to a lifting column 802 in a penetrating manner. A bottom of the lifting column 802 is fixedly connected to a floating piston 89. An upper surface of the liquid supply tank 84 is in threaded connection with an external thread tube 803 in a penetrating manner. A bottom of the external thread tube 803 is rotatably connected to a control guide column 813, and the control guide column 813 is fixed to a top of the liquid supply transfer tube 87. The control piston 88 is controlled by an adjustment plate 800 and the floating piston 89 to add or stop adding the wet wipe liquid into the liquid supply tank 84, thus quantitatively adding the wet wipe liquid into the wet wipe carrier. The up-down movement of the external thread tube 803 can control the liquid supply transfer tube 87 to move up and down, thereby controlling the adding amount of the wet wipe liquid. Furthermore, a portion of the control piston 88 that is located below the liquid supply transfer tube 87 is made of a rubber material. When the liquid supply transfer tube 87 moves up and down, the control piston 88 can be controlled normally by the adjustment plate 800.

The positions, which are located below the linear guide rails 2, on the two parallel inner walls of the spraying base 1 are fixedly connected to jacking plates 11. Two symmetrically arranged through slots 801 are formed in sides, which are close to the liquid supply transfer tube 87, of two parallel inner walls of the liquid supply tank 84. An adjustment plate 800 is arranged below the control piston 88. The adjustment plate 800 is slidably connected to the through slots 801 in a penetrating manner. Inner walls of the through slots 801 and the adjustment plate 800 are blocked by rubber soft films. When the liquid supply tank 84 drops, the jacking plates 11 can jack the adjustment plate 800, which can make the control piston 88 float to block the liquid supply transfer tube 87. That is, when the liquid supply tank 84 drops for spraying, new wet wipe liquid will not be added into the liquid supply tank 84, thus achieving quantitative spraying. The blocking performed by the rubber soft films can avoid leakage of the wet wipe liquid from the through slots 801.

A limiting slot 805 is formed in an inner wall of the external thread tube 803. An outer wall of the lifting column 802 is fixedly connected to two symmetrically arranged limiting blocks 806. The limiting blocks 806 are slidably connected to the limiting slot 805 at a corresponding position. The mutual cooperation between the limiting slot 805 and the limiting blocks 806 can achieve vertical lifting of the lifting column 802, and the lifting column 802 cannot fall off from the external thread tube 803.

The upper surface of the liquid supply tank 84 is fixedly connected to a plurality of uniformly distributed limiting columns 82. An upper surface of the power trolley 80 is fixedly connected to a limiter 81 in a penetrating manner. The plurality of limiting columns 82 are slidably connected to the limiter 81 at a corresponding position in a penetrating manner. A plurality of uniformly distributed buffer springs 86 are fixedly connected between the upper surface of the liquid supply tank 84 and a lower surface of the power trolley 80. The limiting columns 82 cooperate with the limier 81 to cause the liquid supply tank 84 to move in a vertical direction under the action of the Z-shaped rails 9. The power trolley 80 provides power for movement of the liquid supply tank 84, and the buffer springs 86 cause the liquid supply tank 84 to move more stably and gently in the vertical direction.

The working principle of this embodiment is as follows: Prepared wet wipe liquid is added into the liquid storage tank 4. The external thread tube 803 is rotated to rise and drop the external thread tube 803 and the liquid supply transfer tube 87, so that a volume space between a lower part of the liquid supply transfer tube 87 and the inner bottom wall of the liquid supply tank 84 is a volume of wet wipe liquid required by the wet wipe carrier. In this case, the wet wipe liquid is added into the liquid supply tank 84 along the conveying hose 83 and the internal hose 812. When a liquid level in the liquid supply tank 84 rises, the floating piston 89 moves upwards and drives the control piston 88 to move upwards, so that the bottom of the liquid supply transfer tube 87 is blocked, and no wet wipe liquid will be added into the liquid supply tank 84.

The driving motor 5 is started to cause the synchronous belt wheels 6 to call the synchronous conveyor belt 7 for transmission, and a wet wipe carrier to be sprayed is conveyed. When the wet wipe carrier is moved to the photoelectric sensors 10, the power trolley 80 is powered on to move, so that the liquid supply tank 84 is located directly above the wet wipe carrier. When the liquid supply tank 84 moves to the position below the Z-shaped rails 9, the adjustment plate 800 moves upwards under the action of the lifting plates 11, so that the control piston 88 continues to block the liquid supply transfer tube 87.

When the liquid supply tank 84 drops, the trigger head 811 is in contact with a surface of the wet wipe carrier, and the trigger head 811 is pressed. The plug 808 is pushed upwards, and the wet wipe liquid flows out from the outer spraying tube 804, so that the wet wipe liquid is uniformly absorbed by the wet wipe carrier, and the spraying on the wet wipe carrier can be completed. After the spraying is completed, the power trolley 80 moves back and is reset.

When the liquid supply tank 84 moves to the position above the Z-shaped rails 9 again, the lifting plates 11 can no longer press the control piston 88, and the floating piston 89 falls down under the action of gravity. Therefore, the liquid supply tank 84 can quantitatively add wet wipe liquid again, to spray a wet wipe carrier conveyed from the back.

The foregoing descriptions are merely preferred embodiments of the present disclosure and are not intended to limit the protection scope of the present disclosure.

What is claimed is:

1. A wet wipe liquid spraying structure for wet wipe production, comprising a transmission system arranged on an inner side of a spraying base (1), wherein
two parallel inner walls of the spraying base (1) are fixedly connected to two symmetrically arranged linear guide rails (2); a uniform liquid supplier (8) is arranged between the two linear guide rails (2);
the uniform liquid supplier (8) comprises a power trolley (80) and a liquid supply tank (84) arranged below the power trolley (80); one side of the liquid supply tank (84) is fixedly connected to an internal hose (812) in a penetrating manner; one end, away from an inner wall of the liquid supply tank (84), of the internal hose (812) is connected to a liquid supply transfer tube (87) through a pipeline; a plurality of uniformly distributed contact spraying heads are arranged on a lower surface of the liquid supply tank (84) in a penetrating manner;
a bottom of the liquid supply transfer tube (87) is opened; a surface of the liquid supply transfer tube (87) is slidably connected to a control piston (88) in a penetrating manner; one side of a surface of the control piston (88) is slidably connected to a lifting column (802) in a penetrating manner; a bottom of the lifting column (802) is fixedly connected to a floating piston (89); an upper surface of the liquid supply tank (84) is in threaded connection with an external thread tube (803) in a penetrating manner; a bottom of the external thread tube (803) is rotatably connected to a control guide column (813), and the control guide column (813) is fixed to a top of the liquid supply transfer tube (87);
positions, which are located below the linear guide rails (2), on the two parallel inner walls of the spraying base (1) are fixedly connected to jacking plates (11); two symmetrically arranged through slots (801) are formed in sides, which are close to the liquid supply transfer tube (87), of two parallel inner walls of the liquid supply tank (84); an adjustment plate (800) is arranged below the control piston (88); the adjustment plate (800) is slidably connected to the through slots (801) in a penetrating manner; inner walls of the through slots (801) and the adjustment plate (800) are blocked by rubber soft films;
the upper surface of the liquid supply tank (84) is fixedly connected to a plurality of uniformly distributed limiting columns (82); an upper surface of the power trolley (80) is fixedly connected to a limiter (81) in a penetrating manner; the plurality of limiting columns (82) are slidably connected to the limiter (81) at a corresponding position in a penetrating manner; a plurality of uniformly distributed buffer springs (86) are fixedly connected between the upper surface of the liquid supply tank (84) and a lower surface of the power trolley (80);
a limiting slot (805) is formed in an inner wall of the external thread tube (803); an outer wall of the lifting column (802) is fixedly connected to two symmetrically arranged limiting blocks

(806) ; the limiting blocks (806) are slidably connected to the limiting slot (805) at a corresponding position;
each of the plurality of contact spraying heads comprises an outer spraying tube (804) fixedly connected to a bottom of the liquid supply tank (84) in a penetrating manner; an inner wall of the outer spraying tube (804) is fixedly connected to an annular supporting ring (809); a plug (808) is arranged above the outer spraying tube (804); a reset spring (807) is fixedly connected between a lower surface of the plug (808) and an upper surface of the supporting ring (809);
a center of the lower surface of the plug (808) is fixedly connected to a sliding rod (810); a bottom of the sliding rod (810) is fixedly connected to a trigger head (811); the plug (808) is located above an inner bottom wall of the liquid supply tank (84), and the trigger head (811) is located below the liquid supply tank (84);
the positions, which are located below the linear guide rails (2), on the two parallel inner walls of the spraying base (1) are fixedly connected to Z-shaped rails (9); starting positions of the Z-shaped rails (9) are fixedly connected to photoelectric sensors (10); two sides of the liquid supply tank (84) are rotatably connected to limiting wheels (85); the limiting wheels (85) are in rolling connection with the Z-shaped rails (9) at corresponding positions; and a power wheel of the power trolley (80) is in rolling connection with the linear guide rails (2) at corresponding positions.

2. The wet wipe liquid spraying structure for wet wipe production according to claim 1, wherein
an upper surface of the spraying base (1) is fixedly connected to a fixed mounting platform (3); a surface of the fixed mounting platform (3) is fixedly connected to a liquid storage tank body (4); the liquid storage tank body (4) is connected to the internal hose (812) of the liquid supply tank (84) through a conveying hose (83); the transmission system comprises two symmetrically arranged synchronous belt wheels (6) that are rotatably connected to the spraying base (1); a synchronous conveyor belt (7) is arranged between the two synchronous belt wheels (6); a side wall of the spraying base (1) is fixedly connected to a driving motor (5); and a driving end of the driving motor (5) is connected to rotating shafts of the synchronous belt wheels (6) at corresponding positions.
